(19) United States
(12) Patent Application Publication
(10) Pub. No.: US 2009/0008192 A1
(43) Pub. Date: Jan. 8, 2009

(54) ELEVATOR

(75) Inventors: Kazuhiro Tanaka, Tokyo-To (JP); Shigeru Takaishi, Shanhai City (CN); Kan Kawasaki, Tokyo-To (JP); Ikuo Asami, Saitama-Ken (JP); Toshinori Iwai, Tokyo-To (JP)

Correspondence Address: FOLEY AND LARDNER LLP;SUITE 500, 3000 K STREET NW, WASHINGTON, DC, 20007, US

(73) Assignee: Tobishba Elevator Kabushiki Kaisha

(21) Appl. No.: 11/816,460

(22) PCT Filed: Feb. 27, 2006
(86) PCT No.: PCT/JP2006/303584

§ 371 Date: Dec. 18, 2007

(30) Foreign Application Priority Data
Mar. 1, 2005 (JP) 2005-056038

(51) Int. Cl. B66B 11/08

(52) U.S. Cl. 187/266

(57) ABSTRACT

An elevator has a machineroom of a comparatively low height so designed that a sufficiently large working space necessary for inspection and maintenance work is available in the machineroom and a hoist cable can be wound round a traction sheave disposed in the machineroom at a large contact angle. The elevator has a cage provided with front and back cage-side sheaves and suspended for vertical movement in an elevator shaft, and a counterweight that moves vertically in a space behind a vertical plane containing the back wall of the cage in the elevator shaft. The traction sheave and a drive unit for driving the traction sheave are disposed in the machineroom with their axes laterally extended. The back cage-side sheave lies below the traction sheave.

### BACKGROUND OF THE INVENTION

1. Field of the Invention

The present invention relates to an elevator including a cage and a counterweight that moves vertically in a space behind a space in which the cage moves. More specifically, the present invention relates to an improved elevator providing a large space available for inspection in a machineroom where a hoist and such are installed and capable of winding a hoist cable around a traction sheave in a large contact angle without increasing the height of the machineroom.

2. Description of the Related Art

In a known elevator disclosed in JP-A 8-175776, a machineroom is disposed above an elevator shaft, in which a cage and a counterweight move vertically, and a hoist and associated machines are installed in the machineroom.

For example, in a known elevator shown in FIG. 11, a hoist 2, a traction sheave 3 and a deflector sheave 4 are held on a machine bed 5 placed in the machineroom 1. The hoist 2 drives the traction sheave 3 for rotation. A cage and a counterweight, which are not shown, are suspended like well buckets in an elevator shaft by a main cable 6 wound round the traction sheave 3 and the deflector sheave 4 so as to counterbalance each other. The hoist 2 is disposed in a central part of the machineroom 1 to suspend the cage in the elevator shaft. Thus a space around the hoist 2 is available as a working space for work for inspecting and maintaining the hoist 2 and other machines in the machineroom 1.

Building laws and elevator safety standards enforced in Japan differ from those enforced in other countries. Some countries legally require that a working space of an area not smaller than a specified area for inspection and maintenance work ought to be secured in the machineroom. The working space surrounding the hoist 2 cannot meet the elevator safety standards of the country and hence the machineroom unavoidably needs to have a floor area greater than the horizontal sectional area of the elevator shaft.

In the known elevator shown in FIG. 11, the deflector sheave 4 is obliged to be disposed near the inside surface 1a of the back wall of the machineroom 1 such that a part 6a of the main cable 6 extending down from the deflector sheave 4 extends along the back surface of the elevator shaft, when the counterweight is suspended so as to moves vertically along the back surface of the elevator shaft. Consequently, the traction sheave 3 and the deflector sheave 4 are spaced horizontally apart. When the traction sheave 3 and the deflector sheave 4 are thus arranged, the traction sheave 3 needs to be disposed at a considerably elevated position relative to the deflector sheave 4 to wind the main cable 6 round the traction sheave 3 at a large contact angle, which inevitably increases the height of the machineroom 1. If the traction sheave 3 and the deflector sheave 4 are disposed horizontally close to each other, the cage cannot be formed in a big depth due to a restriction placed by the position of the part 6a extending down from the deflector sheave 4 and the position of a space in which the counterweight moves vertically. Thus, the known elevator shown in FIG. 11 is subject to many restrictions placed by the deflector sheave 4.

### SUMMARY OF THE INVENTION

Accordingly, it is an object of the present invention to solve those problems in the prior art and to provide an elevator including a cage, a counterweight that moves vertically behind the cage and a hoist installed in a machineroom, having a sufficient working space for the inspection and maintenance of the hoist and other machines in the machineroom, and capable of winding a main cable round a traction sheave at a large contact angle without increasing the height of the machineroom.

The present invention provides an elevator including:

a cage vertical moving in an elevator shaft guided by right and left cage guide rails;

a counterweight vertically moving in a back space between a vertical plane containing a back wall of the cage and a back wall of the elevator shaft, and having a weight-side sheave;

a traction sheave rotating around a laterally and horizontally extended axis disposed at a position above the back wall of the cage in a machineroom constructed on top of the elevator shaft;

a drive unit disposed in the machineroom for driving the traction sheave for rotation;

a pair of front and back cage-side sheaves supported on a top wall of the cage, said back cage-side sheaves disposed near the back wall of the cage when viewed vertically from above;

a hoist cable wound around the traction sheave for suspending the cage with a cage-side end part thereof via the pair of front and back cage-side sheaves and for suspending the counterweight with a weight-side end part thereof via the weight-side sheave; and

a pair of cable hitching devices respectively holding the cage-side and the weight-side end part of the hoist cable.

In the elevator of the present invention, the traction sheave is disposed at a position above the back wall of the cage and near the back wall of the machineroom in the machineroom. Therefore, the drive unit for driving the traction sheave for rotation can be disposed near the back surface of the machineroom and hence a sufficiently large working space for the inspection and maintenance of the drive unit and other associated machines can be secured in the machineroom.

Since the counterweight and the back cage-side sheave lie below the traction sheave in the elevator according to the present invention, the hoist cable can be wound around the traction sheave at a large contact angle without increasing the height of the machineroom.

Since the elevator according to the present invention does not include any deflector sheave, the depth dimension, namely, the depth of the cage is not subject to any restriction that may be placed by the position of a deflector sheave. Consequently, the depth dimension of the cage can be increased so far as the relation between the cage and the counterweight permits.

The weight-side cable hitching device is disposed near the drive unit in the machineroom. Therefore, the drive unit can be spaced from the weight-side cable hitching device by disposing the drive unit opposite to the weight-side cable hitching device with respect to the traction sheave in a lateral direction.

The drive unit can be spaced from the weight-side cable hitching device in a depth direction by disposing the drive unit with the axis thereof inclined slightly to a lateral direction.

The weight-side cable hitching device can be spaced apart from the drive unit in a depth direction by disposing the weight-side sheave with its axis slightly inclined to the depth direction.

The drive unit and the weight-side cable hitching device can be spaced apart from each other in a depth direction by employing a motor having a small diameter and a long axial length as the drive unit.

The drive unit and the weight-side cable hitching device can be spaced apart from each other in a lateral direction by employing a motor having a big diameter and a short axial length as the drive unit.

When the counterweight is provided with a right and a left weight-side sheave, the weight-side cable hitching device can be spaced apart from the drive unit in a lateral direction. The cage-side and the weight-side cable hitching devices can be held on a single holding beam extended in a depth direction by disposing the right and the left weight-side sheave properly on the counterweight so that the cage-side and the weight-side cable hitching devices can be disposed side by side in a depth direction.

In the elevator according to the present invention having the cage and the counterweight that moves vertically in a space behind a space in which the cage moves vertically, a sufficiently large working space for the inspection and maintenance of the hoist and other associated machines can be secured in the machineroom and the main cable can be wound around the traction sheave at a large contact angle without increasing the height of the machineroom.

### BRIEF DESCRIPTION OF THE DRAWINGS

FIG. 1 is a perspective view of an elevator in a preferred embodiment according to the present invention taken diagonally from the front right-hand side of the elevator;

FIG. 2 is a perspective view of the elevator shown in FIG. 1 taken diagonally from the back right-hand side of the elevator;

FIG. 3 is a typical plan view of the elevator shown in FIG. 1;

FIG. 4 is a typical plan view of an elevator in a first modification of the elevator shown in FIG. 1;

FIG. 5 is a typical plan view of an elevator in a second modification of the elevator shown in FIG. 1;

FIG. 6 is a typical plan view of an elevator in a third modification of the elevator shown in FIG. 1;

FIG. 7 is a typical plan view of an elevator in a fourth modification of the elevator shown in FIG. 1;

FIG. 8 is a typical plan view of an elevator in a fifth modification of the elevator shown in FIG. 1;

FIG. 9 is a typical plan view of an elevator in a sixth modification of the elevator shown in FIG. 1;

FIG. 10 is a typical plan view of the elevator in the first modification; and

FIGS. 11(a) and 11(b) are a schematic plan view and a schematic side elevation, respectively, of a prior art elevator.

### DESCRIPTION OF THE PREFERRED EMBODIMENTS

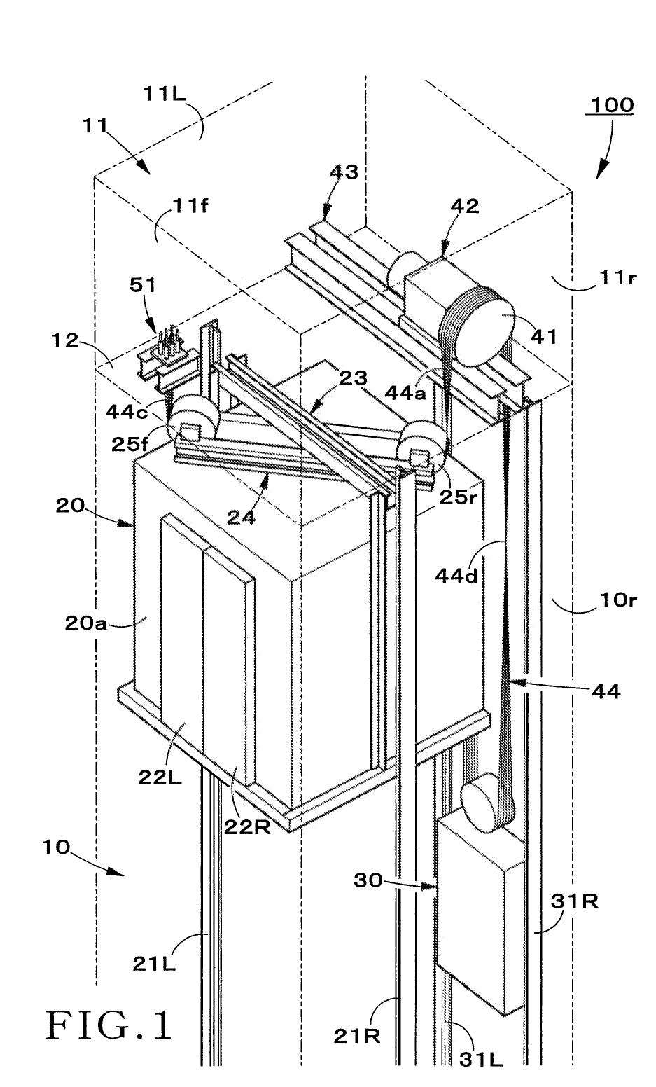

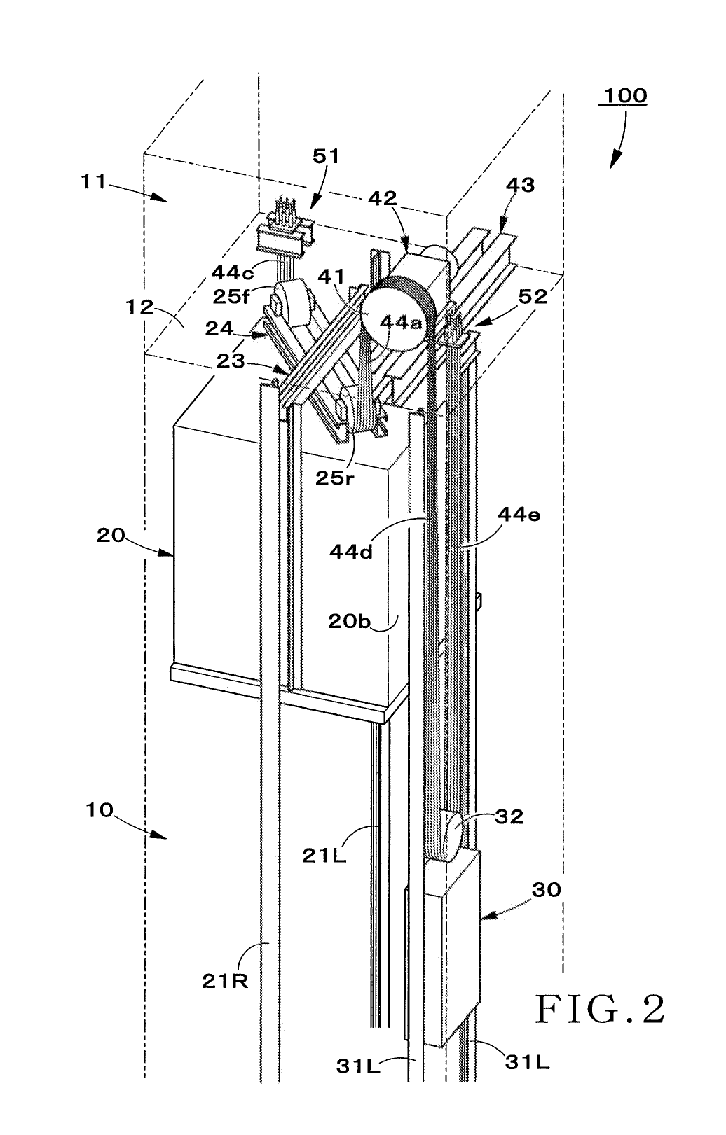

Elevators according to the present invention will be described with reference to FIGS. 1 to 10. In the following direction, the term “lateral direction” is used to indicate a direction in which a door of a cage is opened and closed, the term “depth direction” is used to indicate a direction in which a person enters or exits the cage, and the term “vertical direction” is used to indicate a direction in which the cage moves upward or downward, and like parts are denoted by the same reference characters and the duplicate description of like parts will be omitted.

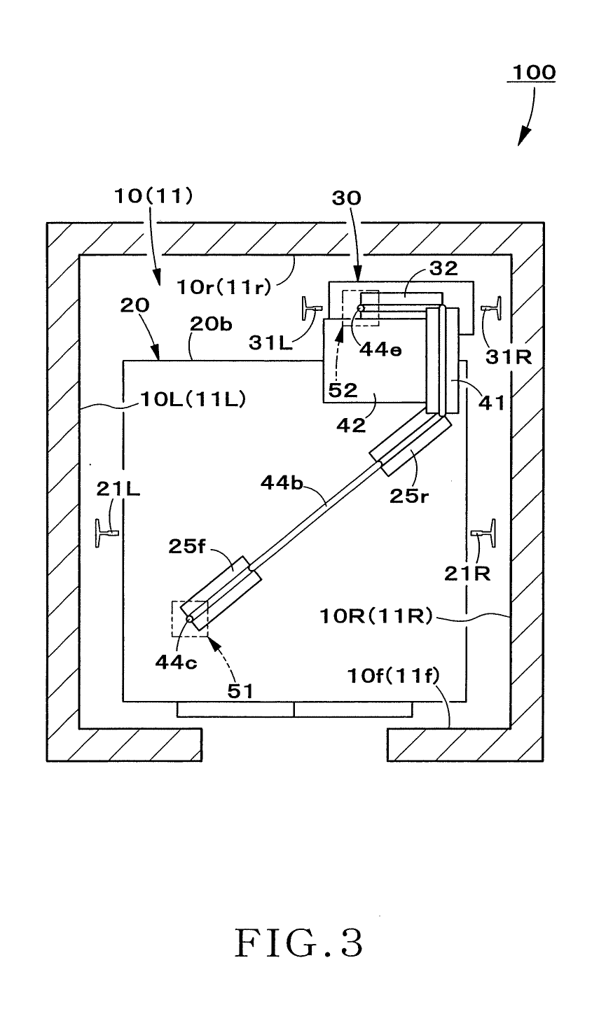

An elevator 100 in a preferred embodiment according to the present invention will be described with reference to FIGS. 1 to 3. The elevator 100 has an elevator shaft 10 in which a cage 20 and a counterweight 30 move vertically, and a machineroom 11 having a floor area equal to the area of a horizontal section of the elevator shaft 10. The machineroom 11 is formed on top of the elevator shaft 10. Referring to FIG. 3, the elevator shaft 10 has a front wall 10f, a back wall 10 r, a right wall 10R and a left wall 10L. The machineroom 11 has a front wall 11f, a back wall 11r, a right wall 11R and a left wall 11L.

A right cage guide rail 21R and a left cage guide rail 21L guides the cage 20 for vertical movement in the elevator shaft 10. The cage 20 is provided with a right door 22R and a left door 22L. The right door 22R and the left door 22L move laterally in opposite directions, respectively, to open and close an opening formed in the front wall 20a of the cage 20. A cage frame supporting the cage 20 has an upper beam 23 and a sheave supporting beam 24. The upper beam 23 extends horizontally laterally above the cage 20. The sheave supporting beam 24 has an upper surface in contact with a middle part of the upper beam 23 and extends in a horizontal plane at an angle to the upper beam 23. A front cage-side sheave 25f and a back cage-side sheave 25r are supported on the opposite end parts of the sheave supporting beam 24 near the front wall 20a and the back wall 20b, respectively, of the cage 20.

The counterweight 30 is suspended so as to move in a back space between a vertical plane containing the back wall 20b of the cage 20 and the back wall 10r of the elevator shaft 10. A right counterweight guide rail 31R and a left counterweight guide rail 30L guide the counterweight 30 for vertical movement in the back space in the elevator shaft 10. A weight-side sheave 32 is supported for rotation on the counterweight 30 with its axis extended in a depth direction.

A traction sheave 41 is disposed near the back wall 11r of the machineroom 11 in the machineroom 11. The traction sheave 41 rotates about a horizontally and laterally extending axis. A drive unit 42 drives the traction sheave 41 for rotation. The drive unit 42 is disposed coaxially with the traction sheave 41 and is mounted on a machine bed 43 laterally extended on the floor 12 of the machineroom 11. As shown in FIG. 3, the traction sheave 41 and the drive unit 42 are disposed above the back wall 20b of the cage 20 in the machineroom 11. As viewed in a vertical direction, at least parts of the traction sheave 41 and the drive unit 42 overlap the cage 20.

A hoist cable 44 wound round the traction sheave 41 consists of a plurality of wire strands of a diameter between 4 and 6 mm. The cage 20 and the counterweight 30 are suspended like well buckets in the elevator shaft 10 by the hoist cable 44. The hoist cable 44 has a first vertical part 44a extending vertically down from the traction sheave 41 through the floor 12 of the machineroom 11 toward the cage 20, a horizontal part 44b (FIG. 3) horizontally extending between the cage-side sheaves 25f and 25r, a second vertical part extending upward from the front cage-side sheave 25f through the floor 12 of the machineroom 12 and having an upper end connected to the cage-side cable hitching device 52, a third vertical part 44d extending vertically down from the traction sheave 41 through the floor 12 of the machineroom 11 toward the counterweight 30, and a fourth vertical part 44e extending vertically up from the weight-side sheave 32 through the floor 12 of the machineroom 11 and having an upper end connected to the weight-side cable hitching device 52.

The cage-side cable hitching device 51 is disposed on the floor 12 of the machineroom 11 in a corner where the left wall 11L and the front wall 11f of the machineroom 11 meet. The weight-side cable hitching device 52 is disposed on the floor 12 of the machineroom 11 and is connected to the back surface of the machine bed 43 supporting the drive unit 42 thereon.

In the elevator 100, the traction sheave 41 is disposed in the machineroom 11 at a position near the back wall 11r of the machineroom 11 and above the back wall 20b of the cage 20. Therefore, the drive unit 42 for driving the traction sheave 41 for rotation can be disposed near the back wall 11r of the machineroom 11. Consequently, a sufficiently large working space for the inspection and maintenance of the drive unit 42 and other machines can be secured in the machineroom 11.

In the elevator 100, the counterweight 30 and the back cage-side sheave 25r are below the traction sheave 41. Thus the hoist cable 44 can be wound round the traction sheave 41 at a contact angle equal to about 180° or larger and, therefore, the traction of the traction sheave 41 can be efficiently transmitted to the hoist cable 44.

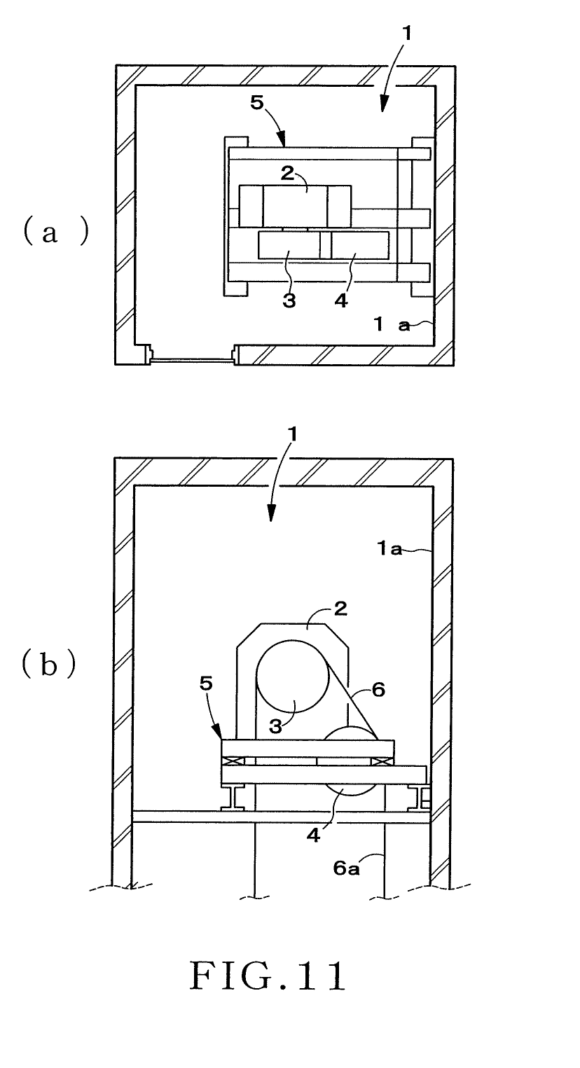

The elevator 100 is not provided with any deflector sheave. Therefore, the machineroom 11 does not need to be constructed in a big height like the machineroom of the prior art elevator shown in FIG. 11 to wind the hoist cable 44 round the traction sheave 41 at a large contact angle. The depth dimension of the cage 20 is not subject to any restrictions that may be placed by a deflector sheave and the cage 20 can be in the largest possible depth dimension so far as the positional relation between the cage 20 and the counterweight 30 permits.

### First Modification

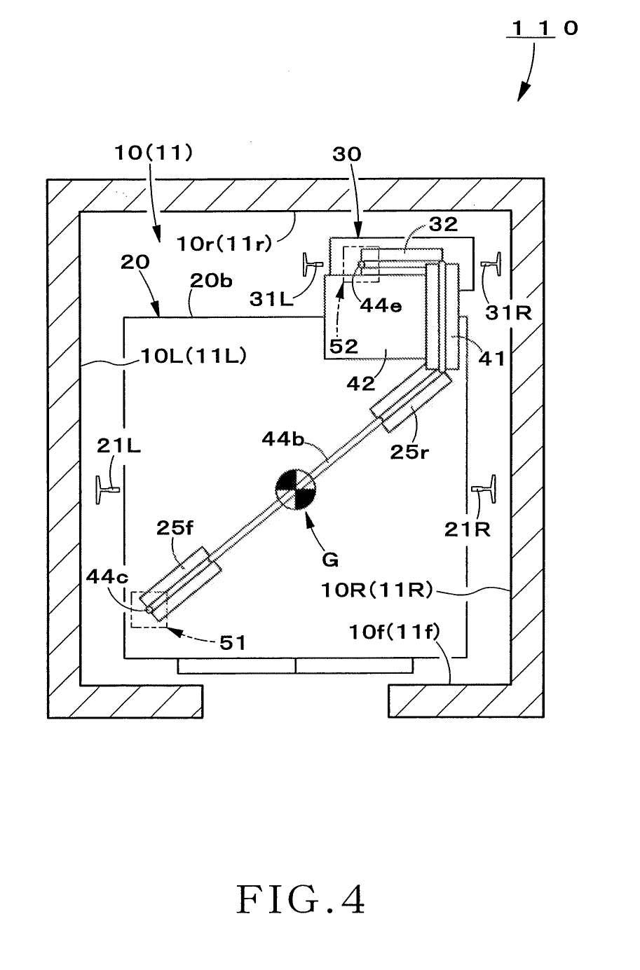

Referring to FIG. 4 showing an elevator 110 in a first modification of the elevator 100, a front cage-side sheave 25f and a back cage-side sheave 25r are disposed symmetrically with respect to a vertical axis passing the center G of gravity of a cage 20 in a horizontal plane; that is, the front cage-side sheave 24f and the back cage-side sheave 24r are disposed such that a part 44b of a hoist cable 44 extending between the front cage-side sheave 24f and the back cage-side sheave 24r crosses the vertical axis passing the center G of gravity of the cage 20. Thus the front cage-side sheave 24f and the back cage-side sheave 24r are at equal distances from the vertical axis passing the center G of gravity of the cage 20. A right cage guide rail 21R and a left cage guide rail 21L are disposed symmetrically with respect to the vertical axis passing the center G of gravity of the cage 20. Thus the cage 20 can be suspended stably so as not to incline.

### Second Modification

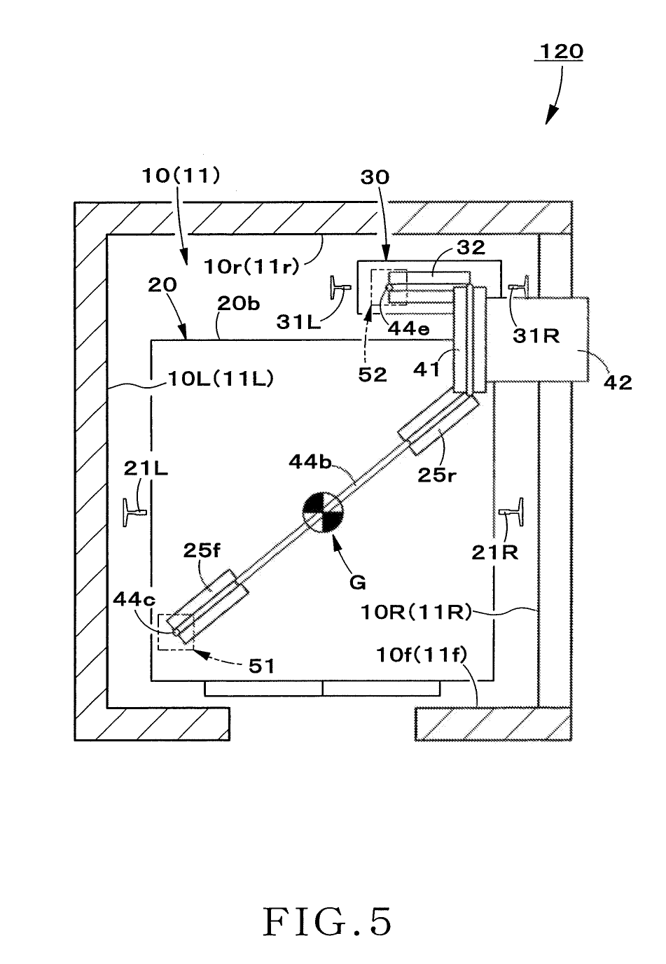

Referring to FIG. 5 showing an elevator 120 in a second modification of the elevator 100, a drive unit 42 for driving a traction sheave 41 for rotation is disposed laterally opposite to a weight-side cable hitching device 52 with respect to the traction sheave 41 in an expanded part of a machineroom 11. Thus the drive unit 42 can be spaced a sufficient distance apart form the weight-side cable hitching device 52, which facilitates work for the inspection and maintenance of the drive unit 42 and the weight-side cable hitching device 52.

### Third Modification

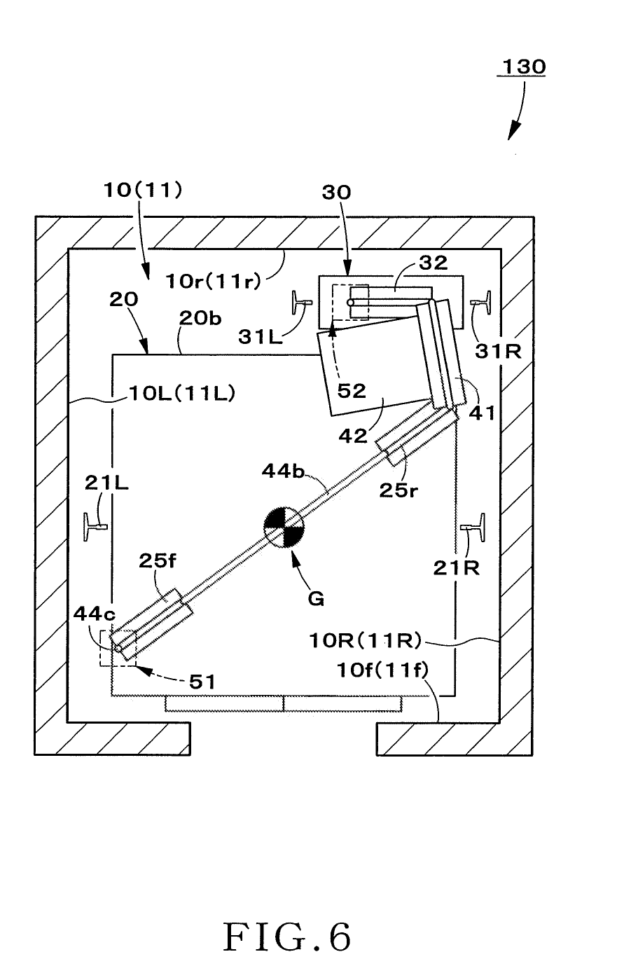

Referring to FIG. 6 showing an elevator 130 in a third modification of the elevator 100, a drive unit 42 and a traction sheave 41 are disposed with their axes inclined at a small angle to a lateral direction to space the drive unit 41 forward apart from a weight-side cable hitching device 52.

### Fourth Modification

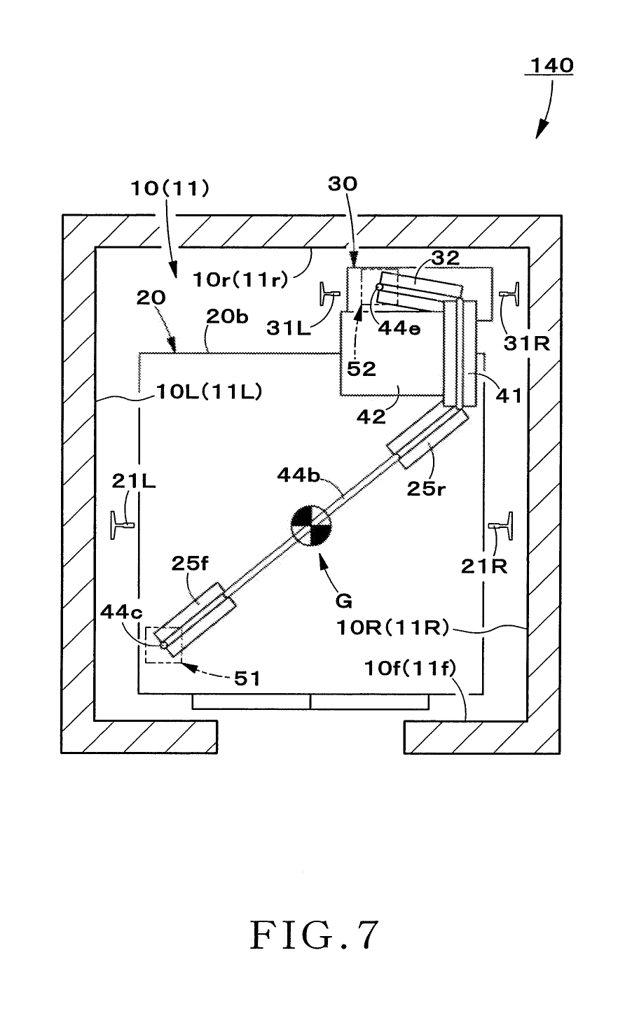

Referring to FIG. 7 showing an elevator 140 in a fourth modification of the elevator 100, a weight-side sheave 32 is disposed with its axis inclined at a small angle to a depth direction to space a weight-side cable hitching device 52 backward apart from a drive unit 42.

### Fifth Modification

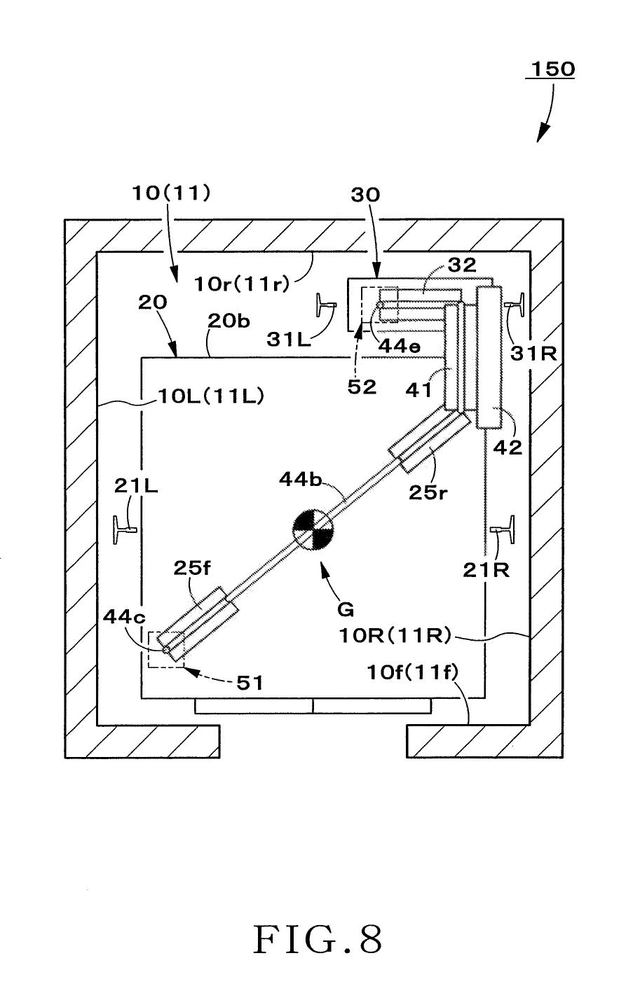

Referring to FIG. 8 showing an elevator 150 in a fifth modification of the elevator 100, a drive unit 41 includes a motor having a big diameter and a short axial length. The drive unit 42 is laterally farther from a weight-side cable hitching device 52 than a traction sheave 41. Since the drive unit 42 includes the motor having a big diameter and a short axial length, the drive unit 42 can be contained in a machineroom 11 having a floor area equal to the horizontal sectional area of an elevator shaft 10. Also, when the drive unit 42 includes a motor having a small diameter and a long axial length, interference between the drive unit 42 and a weight-side cable hitching device 52 in a depth direction can be avoided, even if the elevator 150 is the same in construction as the elevator 100 shown in FIG. 3 or 4.

### Sixth Modification

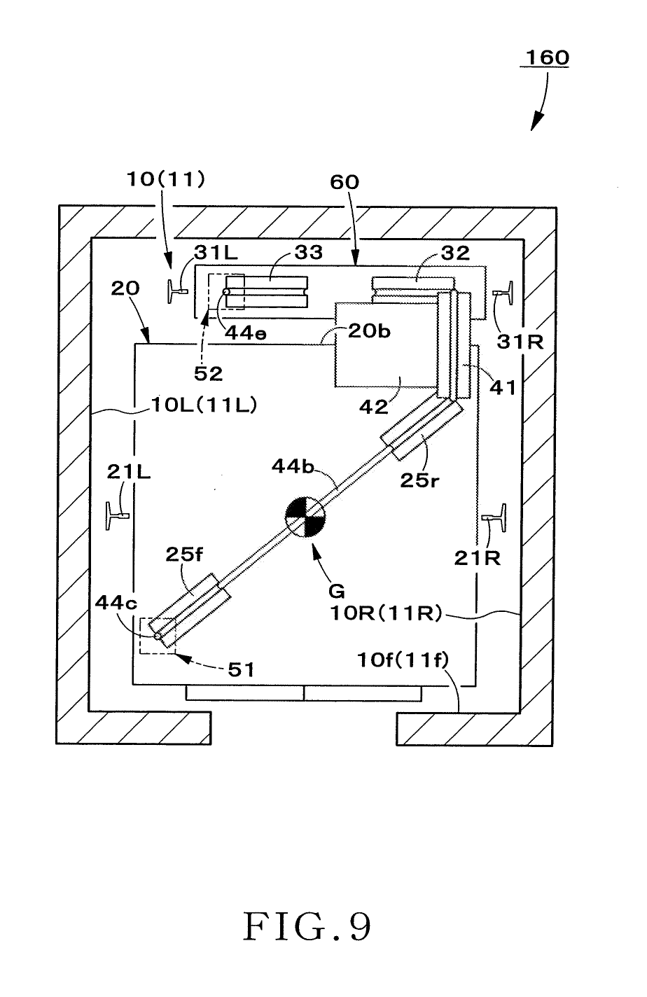

Referring to FIG. 9 showing an elevator 160 in a sixth modification of the elevator 100, the elevator 160 has a large cage 20 and a large, wide counterweight 60 of a weight counterbalancing that of the large cage 20. The counterweight 60 has a width, namely, a lateral dimension, greater than that of the counterweight 30 of the elevator 100 shown in FIG. 3. The wide counterweight 60 is provided with two weight-side sheaves 32 and 33. Therefore, a weight-side cable hitching device 52 is shifted to the left from the position of the weight-side cable hitching device 52 of the elevator 100 shown in FIG. 3. Therefore, in the elevator 160, the weight-side cable hitching device 52 will not interfere with a drive unit 42.

### Seventh Modification

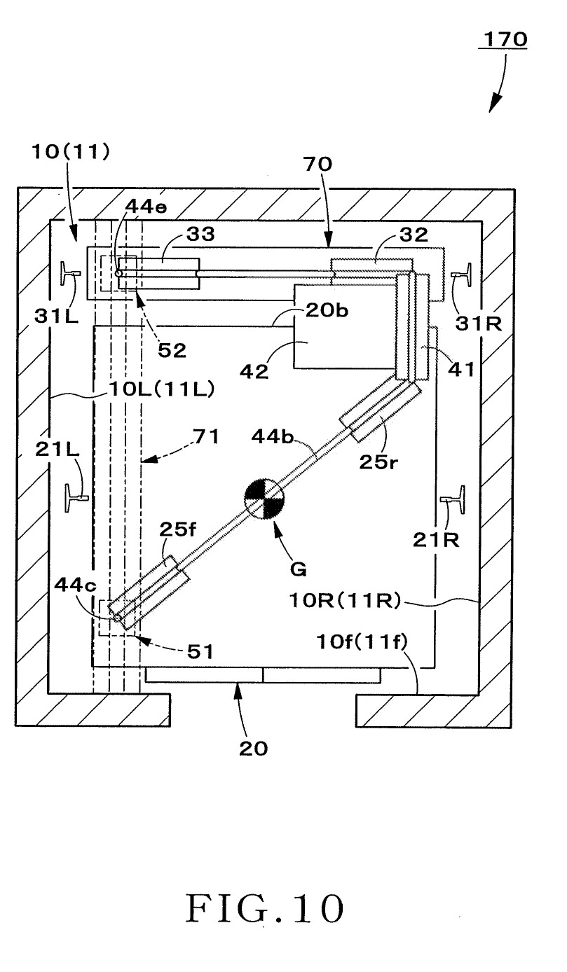

Referring to FIG. 10 showing an elevator 170 in a seventh modification of the elevator 100, the elevator 170 is substantially the same in construction as the elevator 160 in the sixth modification. The elevator 170 includes a counterweight 70 larger than the counterweight 160 and provided with two weight-side sheaves 32 and 33. The positions of the weight-side sheaves 32 and 33 are determined so that a cage-side cable hitching device 51 and a weight-side cable hitching device 42 on a line extending in a depth direction and can be held on a single support beam 71.

In each of the foregoing elevators 100 to 170, the traction sheave 41 and the drive unit 42 may be disposed near the left wall 11L of the machineroom 11 instead of near the right wall 11R of the machineroom 11.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

1. An elevator comprising:
a cage vertical moving in an elevator shaft guided by right and left cage guide rails;
a counterweight vertically moving in a back space between a vertical plane containing a back wall of the cage and a back wall of the elevator shaft, and having a weight-side sheave;
a traction sheave rotating around a laterally and horizontally extended axis disposed at a position above the back wall of the cage in a machineroom constructed on top of the elevator shaft;
a drive unit disposed in the machineroom for driving the traction sheave for rotation;
a pair of front and back cage-side sheaves supported on a top wall of the cage, said back cage-side sheaves disposed near the back wall of the cage when viewed vertically from above;
a hoist cable wound around the traction sheave for suspending the cage with a cage-side end part thereof via the pair of front and back cage-side sheaves and for suspending the counterweight with a weight-side end part thereof via the weight-side sheave; and
a pair of cable hitching devices respectively holding the cage-side and the weight-side end part of the hoist cable.

2. The elevator according to claim 1, wherein at least a part of the drive unit overlaps the cage when viewed vertically from above.

3. The elevator according to claim 1, wherein the drive unit is disposed away from the cable hitching device in a depth direction when viewed vertically from above.

4. The elevator according to claim 3, wherein the drive unit extends outside the elevator shaft when viewed vertically from above.

5. The elevator according to claim 3, wherein the drive unit has a big diameter and a short axial length and is disposed inside an elevator shaft when viewed vertically from above.

6. The elevator according to claim 3, wherein the drive unit has a small diameter and a long axial length and is spaced apart from the weight-side cable hitching device in a depth when viewed vertically from above.

7. The elevator according to claim 1, wherein the drive unit is disposed with its axis inclined at an angle to the lateral direction in a horizontal plane and is spaced apart from the weight-side cable hitching device in a depth direction when viewed vertically from above.

8. The elevator according to claim 1, wherein the drive unit has a reduction gear.

9. The elevator according to claim 1, wherein at least a part of the traction sheave overlaps the cage when viewed vertically from above.

10. The elevator according to claim 1, wherein the traction sheave is disposed near either of a right and a left wall of the machineroom.

11. The elevator according to claim 1, wherein the front and the back cage-side sheaves are disposed symmetrically with respect to a center of gravity of the cage when viewed vertically from above.

12. The elevator according to claim 1, wherein the counterweight is provided with right and left weight-side sheaves, and the cage-side and the weight-side cable hitching devices are disposed on a line extending perpendicular to the back wall of the cage.
